(19) United States
(12) Patent Application Publication
(10) Pub. No.: US 2026/0115887 A1
(43) Pub. Date: Apr. 30, 2026

(54) TRAFFIC SIGNAL CABINET CADDY

(71) Applicants: Steve Matthews, Vermontville, MI (US); Cody Matthews, Lansing, MI (US)

(72) Inventors: Steve Matthews, Vermontville, MI (US); Cody Matthews, Lansing, MI (US)

(21) Appl. No.: 18/930,333

(22) Filed: Oct. 29, 2024

(51) Int. Cl. B25H 1/04; A47B 23/00

(52) U.S. Cl. CPC B25H 1/04; A47B 23/001

(57) ABSTRACT

A caddy is an assembly that includes a cylindrical base and a hollow cylinder. The hollow cylinder is operatively connected to the cylindrical base. A support structure is operatively connected to the hollow structure. The cylindrical base comprises a first portion and a second portion that receive a screw, which combine to form a clamping mechanism. The clamping mechanism has a moveable gap. A knob is attached to the screw to adjust the size of the moveable gap of the clamping mechanism.

### TECHNICAL FIELD

The embodiments generally relate to mechanical assemblies, and more specifically to an attachable caddy.

### BACKGROUND

Traffic signal technicians often work with computers and other sensitive electronics. Technicians have to awkwardly balance their equipment or work one-handed, significantly impacting their efficiency and potentially risking damage to sensitive electronics. What is needed is a technical solution that mounts securely to the door opening of a traffic signal cabinet, while also providing a stable platform for laptops and other sensitive electronics.

### SUMMARY OF THE INVENTION

This summary is provided to introduce a variety of concepts in a simplified form that is further disclosed in the detailed description of the embodiments. This summary is not intended for determining the scope of the claimed subject matter.

In the embodiments disclosed herein, a caddy is disclosed. In the caddy, a cylindrical base is configured to receive a screw. The cylindrical base is operatively connected to a first knob. The cylindrical base is composed of a first portion and a second portion. The first portion and the second portion form a clamping mechanism. The clamping mechanism has a gap. A hollow cylinder operatively connected to the cylindrical base. A support structure is operatively connected to the hollow cylinder.

In some aspects, the support structure is V-shaped.

In some aspects, the support structure comprises a protruding rod.

In some aspects, the protruding rod is configured to be received by the hollow cylinder.

In some aspects, the hollow cylinder and the cylindrical base form a L-shaped connection.

In some aspects, the V-shaped support structure is configured to support a flat surface.

In some aspects, the V-shaped support structure has a plurality of holes.

In some aspects, the flat surface is a tray.

In some aspects, the cylindrical base and the support structure are composed of polyethylene terephthalate glycol (PETG).

In some aspects, the plurality of holes is configured to receive a plurality of fasteners.

In some aspects, the hollow cylinder also includes a second knob.

In some aspects, the first knob comprises a pivot operatively connected to the first portion of the cylindrical base.

In some aspects, the pivot of the first knob allows for rotation of the first knob to tighten or loosen the clamping mechanism.

In some aspects, the clamping mechanism is configured for attachment to a lip of a cabinet.

In some aspects, the second portion of the cylindrical base is moveable along the screw.

In some aspects, the second knob comprises a pivot operatively connected to the hollow cylinder and the protruding rod.

In some aspects, the pivot of the second knob allows for rotation to tighten or loosen a connection between the hollow cylinder and the protruding rod.

In some aspects, the protruding rod is configured to slide along the hollow cylinder in a vertical direction and rotate against the hollow cylinder in a circular direction. A height of the support structure, in relation to the cylindrical base, is adjusted. An orientation of the support structure, in relation to the cylindrical base, is adjusted.

In some aspects, the first portion of the cylindrical base comprises a first step structure. The second portion of the cylindrical base comprises a second step structure.

In some aspects, a base step of the first step structure and a base step of the second step structure contact each other to form a gap within the cylindrical base. The gap within the cylindrical base has a variable size associated with a size of the moveable gap of the clamping mechanism.

The embodiments provided herein disclose a caddy as an assembly, wherein the assembly uses a combination of cylindrical bodies, which has a section thereof configured for an attachment mechanism to a door or other surface; and another section thereof configured for a support mechanism that provides a platform for placing a computer or other sensitive electronic equipment thereon.

Unlike other mechanical assemblies, the caddy described herein can be specifically tailored for the stainless steel cabinets that do not allow for magnetic mounts. Using an adjustable knob, the caddy described herein can be quickly installed and removed, while adapting to various cabinet thicknesses. The caddy described herein is therefore a hands-free solution that allows technicians to work more efficiently and for longer periods without fatigue.

Unlike other mechanical assemblies, the caddy described herein is designed with dielectric, thereby ensuring safe use of the caddy described herein, in electrically live cabinets. This feature is crucial given the potentially hazardous environment in which traffic signal technicians often work.

Unlike other mechanical assemblies, which are composed of steel, the caddy described herein is 3D printed, thereby allowing for customization and on-demand production.

By providing a secure, convenient platform for essential equipment, caddy described herein can significantly improve the workflow, safety, and comfort of traffic signal technicians, thereby addressing a critical need in the industry.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an isometric view of a first cylindrical piece, according to some embodiments;

FIG. 2 illustrates a front view of the first cylindrical piece, according to some embodiments;

FIG. 3 illustrates a top view of the first cylindrical piece, according to some embodiments;

FIG. 4 illustrates an isometric view of a second cylindrical piece, according to some embodiments;

FIG. 5 illustrates a top view of the second cylindrical piece, according to some embodiments;

FIG. 6 illustrates a front view of the second cylindrical piece, according to some embodiments;

FIG. 7 illustrates an isometric view of a support structure, according to some embodiments;

FIG. 8 illustrates a top view of the support structure, according to some embodiments;

FIG. 9 illustrates a front view of the support structure, according to some embodiments;

FIG. 10 illustrates the first cylindrical piece and the second cylindrical piece, which are assembled together via a screw, according to some embodiments;

FIG. 11 illustrates the first cylindrical piece and the second cylindrical piece, which are assembled together via the screw to form a clamping mechanism attached to a lip of a cabinet, according to some embodiments; and

FIG. 12 illustrates the first cylindrical piece and the second cylindrical piece, which are assembled together via the screw to form a clamping mechanism attached to the lip of the cabinet, and the support structure, which is attached to the first cylindrical piece and fastened to a tray.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a caddy as an assembly comprising a combination of: (1) cylindrical bodies (i.e., a cylindrical base comprising a first portion and a second portion and a hollow cylinder fused with the first portion of the cylindrical base); and (2) a support structure (i.e., arms extending from a pivot point, wherein the pivot point is attached to a protruding rod that operatively connects to the hollow cylinder), to: provide a sturdy attachment to, for example, the lip of a cabinet door; and support securement placement of, for example, a tray. By attaching the caddy described herein to the lip of the cabinet door and placing the tray on the caddy described herein, a platform is formed for placing a computer or other sensitive electronic equipment thereon.

A caddy is an assembly that includes a cylindrical base and a hollow cylinder. The hollow cylinder is operatively connected to the cylindrical base. A support structure is operatively connected to the hollow structure. The cylindrical base comprises a first portion and a second portion that receive a screw, which combine to form a clamping mechanism. The clamping mechanism has a moveable gap. A knob is attached to the screw to adjust the size of the moveable gap of the clamping mechanism.

It is to be understood that the specific measurements used below are provided by way of example and are not intended to limit the scope of the embodiments disclosed herein. The exemplary measurements serve to provide an exemplary embodiment of a caddy described herein which provides the functions described in this disclosure.

In some embodiments, the caddy described herein is an assembly that may be composed of polyethylene terephthalate glycol (PETG), wherein the assembly comprises (1) cylindrical bodies (i.e., a cylindrical base comprising a first portion and a second portion and a hollow cylinder fused with the first portion of the cylindrical base) operatively connected to (2) a support structure (i.e., arms extending from a pivot point, wherein the pivot point is attached to a protruding rod that operatively connects to the hollow cylinder).

In some embodiments, the first portion and the second portion of the cylindrical base are configured to receive a metal screw through a hole in the first portion and a hole in the second portion.

In some embodiments, the first portion of the cylindrical base and the metal screw are operatively connected to a first knob mechanism.

In some embodiments, the hollow cylinder is operatively connected to a second knob.

In some embodiments, a first cylindrical piece has a hollow cylinder fused with a first portion of the cylindrical base, wherein the first portion of the cylindrical base has a first step structure that can be operatively connected to a second cylindrical piece.

In some embodiments, the first portion of the cylindrical base has a hole with a diameter of 0.39 inches. A screw is fitted through the hole with the diameter of 0.39 inches, in the first portion of the cylindrical base. The first knob is threaded into the screw, while being proximal to the first portion of the cylindrical base.

In some embodiments, the first step structure of the first portion of the cylindrical base has three steps—a lowest step, an intermediate step, and a highest step. The lowest step of the first step structure of the first portion of the cylindrical base has a diameter of 2.24 inches, a length of 2.13 inches, and a height of 2.16 inches. The intermediate step of the first step structure of the first portion of the cylindrical base has a length of 1.38 inches. The highest step of the first step structure of the first portion of the cylindrical base has a diameter of 2.19 inches and a length of 0.9 inches.

In some embodiments, the hollow cylinder, which is fused with the lowest step of the first portion of the of the cylindrical base, has a diameter of 1.75 inches; a hole with a diameter of 0.2 inches; outermost edges of the hollow cylinder each have a height of 1.84 inches; and a portion of the hollow cylinder that extends into the lowest step of the first step structure of the first portion of the cylindrical base has a height of 2.17 inches. The second knob is fitted into the hole with the diameter of 0.2 inches, in the hollow cylinder.

In some embodiments, the second cylindrical piece is the second portion of the cylindrical base, wherein the second portion of the cylindrical base has the second step structure that can be operatively connected to the first portion of the cylindrical base.

In some embodiments, the second portion of the cylindrical base, which has a hole with a diameter of 0.39 inches, has a height of 3.06 inches and a length of 2.00 inches. The screw is fitted through the hole with the diameter of 0.39 inches, in the second portion of the cylindrical base. The first knob is threaded into the screw, while being distal to the second portion of the cylindrical base.

In some embodiments, the second step structure of the second portion of the cylindrical base has three steps—a lowest step, an intermediate step, and a highest step. The lowest step of the second step structure of the second portion of the cylindrical base has a length of 0.46 inches. The intermediate step of the second step structure of the second portion of the cylindrical base has a length of 0.67 inches and a height of 2.18 inches. The highest step of the second step structure of the second portion of the cylindrical base, which has a semicircular shape with a diameter of 1.13 inches and a straight edge with 1.41 inches, has a height of 0.57 inches and a length of 0.5 inches.

In some embodiments, a support structure has two arms operatively connected to a pivot, wherein the pivot is operatively connected to a protruding rod.

In some embodiments, the two arms operatively connected to the pivot has a V-shape, wherein the two arms have holes configured for receiving fasteners, wherein each hole in the two arms has a diameter of 0.19 inches and each arm has a length of 6.46 inches, width of 0.70 inches, and height of 0.70 inches.

In some embodiments, the pivot of the support structure has a diameter of 0.75 inches.

In some embodiments, the protruding rod in the support structure has a diameter of 0.75 inches and a height of 1.9 inches.

The caddy described herein addresses the unique challenges faced by traffic signal technicians by focusing on safety, efficiency, and practicality in a potentially hazardous work environment, which have the following technical advantages, such as specialized application, dielectric safety, 3D printability, simplified design, and non-magnetic attachment.

With respect to specialized application, the caddy described herein is uniquely designed for traffic signal cabinets, addressing a niche but critical need in the field.

With respect to dielectric safety, the caddy described herein is composed of dielectric materials, thereby imparting safe use in electrically live cabinets and focusing on safety in a specific work environment.

With respect to 3D Printability, the caddy described herein is customizable and manufacturable on demand production, thereby offering flexibility and potential cost-effectiveness.

With respect to a simplified design, the caddy described herein offers a simpler, more user-friendly design with an adjustable knob mechanism.

With respect to non-magnetic attachment, the caddy described herein attaches to stainless steel cabinets that do not allow magnetic mounts, thereby addressing a specific challenge in traffic signal maintenance.

To construct the caddy described herein, the first cylindrical piece, the second cylindrical piece, and the support structures are 3D-printed. A screw is fitted through the first cylindrical piece and the second cylindrical piece. The first knob is attached to the screw that has been threaded/fitted through a hole in first cylindrical piece and a hole in the second cylindrical piece, wherein the first cylindrical piece is: (i) the first portion and (ii) the hollow cylinder fused with the first portion; and the second cylindrical piece is the second portion, wherein the first portion and second portion form a cylindrical base for actuating a clamping mechanism with a moveable gap to clamp to a lip of cabinet, wherein the moveable gap varies in size, based on rotation of the first knob. The protruding rod of the supporting structure, which has two arms in a V-shape, can be fitted into the hollow cylinder, wherein the hollow cylinder has a hole as an attachment point for the second knob, wherein the second knob can be rotated, thereby adjusting the force applied against the protruding rod of the supporting structure. A tray is placed on the two arms in a V-shape, which have holes for receiving fasteners; and the fasteners tighten the connection between the tray and the two arms in the V-shape (i.e., a platform). A computer or other sensitive electronics are then placed on the tray.

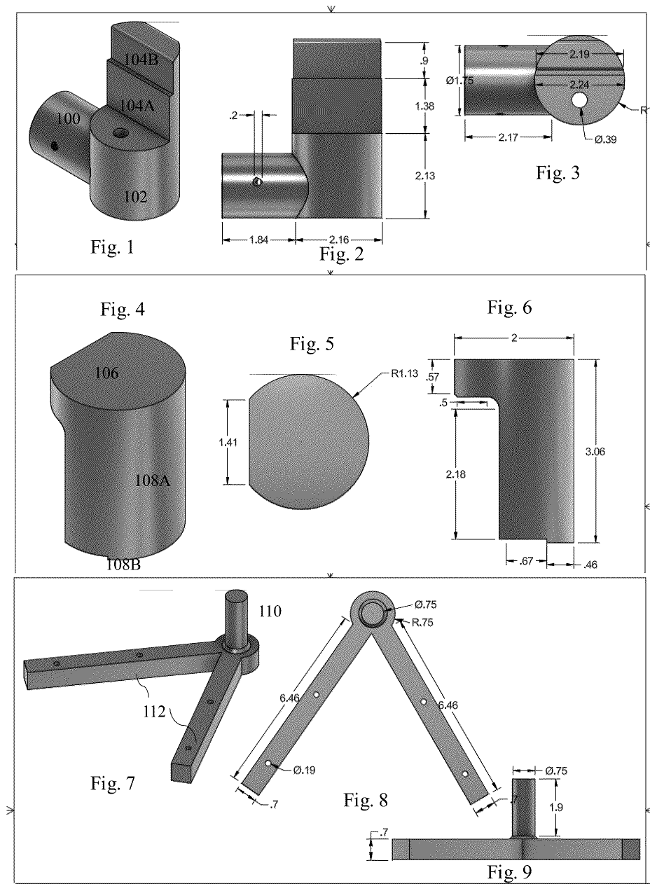

FIG. 1-FIG. 12 illustrate aspects of the caddy described herein, which provide a sturdy attachment to, for example, the lip of a cabinet door; and support securement placement of, for example, a tray. By attaching the caddy described herein to the lip of the cabinet door, via a door lip clamping mechanism, and placing the tray on the caddy described herein, a platform is formed for placing a computer or other sensitive electronic equipment thereon. Destructive testing has been performed, where over 25 pounds was applied against the platform, without damaging the platform, demonstrating load-bearing laptop support, in an ergonomic work surface.

In FIG. 1-FIG. 3, the first cylindrical piece is illustrated, wherein the first cylindrical piece is hollow cylinder 100, wherein hollow cylinder 100 is fused or operatively connected to the first portion of the cylindrical base, wherein the first portion of the cylindrical base has the first step structure comprising: the lowest step (i.e., step 102), the intermediate step (i.e., step 104A), and the highest step (i.e., step 104B). Step 104B is slightly indented inwards, in relation to step 104A. Stated another way, the first portion of the cylindrical base is: step 102, which has a hole for receiving a screw; step 104A; and step 104B.

In FIG. 4-FIG. 6, the second cylindrical piece is illustrated, wherein the second cylindrical piece is a second portion of the cylindrical base, wherein the second portion of the cylindrical base has the second step structure comprising: the lowest step (i.e., step 108B), the intermediate step (i.e., step 108A), and the highest step (i.e., step 106). Step 108B is indented inwards, in relation to step 108A. Stated another way, the second portion of the cylindrical base is: step 108B; step 108A, which has a hole for receiving the screw that is also fitted through step 102; and step 106, which has an open arc such that the ends of the arc are connected by a straight line, as depicted in FIG. 5.

In FIG. 7-FIG. 9, the support structure is illustrated, wherein the support structure has arms 112 (as described above) operatively connected to a pivot point to make a V-shape and the pivot point has protruding rod 110, wherein protruding rod 110 is fitted into hollow cylinder 100 and arms 112 have a plurality of holes configured for receiving fasteners.

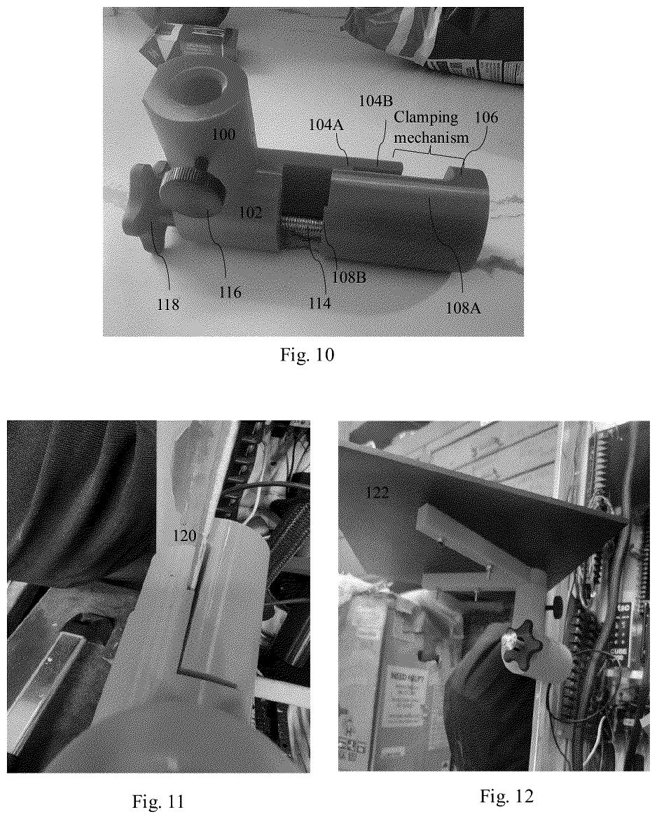

In FIG. 10, the cylinder base (steps 104A, 104B, and 106 in the first portion; and steps 106, 108A, and 108B in the second portion) and hollow cylinder 100 are operatively connected to each other, where: screw 114 is fitted into step 104A of the first portion and step 108B of the second portion; and hollow cylinder 100 is fused to the first portion of the cylinder base at step 104A. Knob 118 (i.e., the first knob) is attached to screw 114 and can be rotated, to control the clamping mechanism ranging from a first gap (smallest) to a second gap (largest). When the screw is fitted through the first portion and the second portion, and step 102 of the first portion and step 108B of the second portion contact each other, the gap of the clamping mechanism is at the first gap. When the screw is fitted through the first portion and the second portion, and step 104B of the first portion and step 106 of the second portion contact each other, the gap of the clamping mechanism is at the second gap. In the clamping mechanism, step 104B of the first portion and step 106 of the second portion can contact the lip of a cabinet or some other surface. Knob 116 (i.e., the second knob) is attached to hollow cylinder 100, wherein knob 116 has a pivot point that contacts cylinder 100 and knob 116 can be rotated for a tightening or loosening effect.

In FIG. 11, knob 118 is rotated such that the clamping mechanism is approaching or at the second gap, where the first portion of the cylinder base and the second portion of the cylinder base are sturdily attached or clamped to surface 120, such as a lip of a cabinet door. As depicted in FIG. 11, the first portion of the cylinder and the second portion of the cylinder base contact each other at step 102 and step 108B, respectively, and another gap appears within the caddy described herein.

In FIG. 12, knob 116 is rotated such that the height and orientation of support structure 112, which is a V-shape, is adjusted, as depicted. Platform 122, such as a tray, can be fastened to support structure 112, while the first portion of the cylinder base and the second portion of the cylinder base are sturdily attached or clamped to surface 120, such as a lip of a cabinet door.

While support structure 112 is depicted as two straight arms forming V-shape, other shapes are possible, such as four straight arms forming a W-shape or a curved arm forming a U-shape.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A caddy comprising
a cylindrical base configured to receive a screw, wherein the cylindrical base is:
operatively connected to a first knob; and
composed of a first portion and a second portion, wherein the first portion and the second portion form a clamping mechanism, wherein the clamping mechanism has a gap;
a hollow cylinder operatively connected to the cylindrical base; and
a support structure operatively connected to the hollow cylinder.

2. The caddy of claim 1, wherein the support structure is V-shaped.

3. The caddy of claim 1, wherein the support structure comprises a protruding rod.

4. The caddy of claim 3, wherein the protruding rod is configured to be received by the hollow cylinder.

5. The caddy of claim 1, wherein the hollow cylinder and the cylindrical base form a L-shaped connection.

6. The caddy of claim 2, wherein the V-shaped support structure is configured to support a flat surface.

7. The caddy of claim 2, wherein the V-shaped support structure has a plurality of holes.

8. The caddy of claim 6, wherein the flat surface is a tray.

9. The caddy of claim 1, wherein the cylindrical base and the support structure are composed of polyethylene terephthalate glycol (PETG).

10. The caddy of claim 7, wherein the plurality of holes is configured to receive a plurality of fasteners.

11. The caddy of claim 1, wherein the hollow cylinder further comprises a second knob.

12. The caddy of claim 1, wherein the first knob comprises a pivot operatively connected to the first portion of the cylindrical base.

13. The caddy of claim 12, wherein the pivot of the first knob allows for rotation of the first knob to tighten or loosen the clamping mechanism.

14. The caddy of claim 13, wherein the clamping mechanism is configured for attachment to a lip of a cabinet.

15. The caddy of claim 1, wherein the second portion of the cylindrical base is moveable along the screw.

16. The caddy of claim 11, wherein the second knob comprises a pivot operatively connected to the hollow cylinder and the protruding rod.

17. The caddy of claim 16, wherein the pivot of the second knob allows for rotation to tighten or loosen a connection between the hollow cylinder and the protruding rod.

18. The caddy of claim 3, wherein the protruding rod is configured to slide along the hollow cylinder in a vertical direction and rotate against the hollow cylinder in a circular direction, thereby adjusting a height of the support structure, in relation to the cylindrical base, and an orientation of the support structure, in relation to the cylindrical base.

19. The caddy of claim 1, wherein the first portion of the cylindrical base comprises a first step structure and the second portion of the cylindrical base comprises a second step structure.

20. The caddy of claim 19, wherein a base step of the first step structure and a base step of the second step structure contact each other to form a gap within the cylindrical base, wherein the gap within the cylindrical base has a variable size associated with a size of the moveable gap of the clamping mechanism.
